(19) United States
(12) Patent Application Publication
(10) Pub. No.: US 2006/0005031 A1
(43) Pub. Date: Jan. 5, 2006

(54) Methods and systems for utilizing a single cryptographic integrity check to generate multiple cryptographic integrity check values for components of transcodable content

(76) Inventor: John G. Apostolopoulos, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/869,654

(22) Filed: Jun. 15, 2004

(51) Int. Cl. H04L 9/00

(52) U.S. Cl. 713/179

(57) ABSTRACT

A method for utilizing a single cryptographic integrity check to generate multiple cryptographic integrity check values for components of transcodable content is disclosed. In one embodiment, a single cryptographic integrity check for content is initiated, where the content includes a plurality of components. It should be appreciated that when the cryptographic integrity check has completed for at least one of the plurality of components, a cryptographic integrity check value is recorded for the at least one of the plurality of components. The single cryptographic integrity check is completed to generate a cryptographic integrity check value for the at least one of the plurality of components.

### BACKGROUND ART

Effective data delivery systems should possess the capacity to deliver data streams to a multitude of diverse clients across heterogeneous networks that possess time-varying characteristics. The design of such data delivery systems present a variety of challenges for the designers of such systems. For instance, clients to which data is being delivered can possess various display, power, communication, and computational capabilities. In addition, communication links in the network over which data is being delivered can possess various maximum bandwidths, quality levels, and time-varying characteristics.

Providing effective security in order to protect content from eavesdroppers is another important consideration in the design of data delivery systems. Generally, to provide security, data is encrypted and transported in encrypted form. Encryption is the conversion of data into a form, called ciphertext that cannot be easily understood by unauthorized receivers. Encryption is important as a means of protecting content when any sensitive transaction is being carried out.

Intermediate nodes in the data delivery system may be used to perform stream adaptation, or transcoding, to scale data streams for different downstream client capabilities and network conditions. A transcoder takes a compressed, or encoded, data stream as an input, and then processes it to produce another encoded data stream as an output. Examples of transcoding operations include bit rate reduction, rate shaping, spatial downsampling, and frame rate reduction. Transcoding can improve system scalability and efficiency, for example, by adapting the spatial resolution of an image to a particular client's display capabilities or by dynamically adjusting the bit rate of a data stream to match a network channel's time-varying characteristics.

While network transcoding facilitates scalability in data delivery systems, it also presents a number of challenges. The process of transcoding can place a substantial computational load on transcoding nodes. While computationally efficient transcoding algorithms have been developed, they may not be well-suited for processing hundreds or thousands of streams at intermediate network nodes.

Furthermore, transcoding poses a threat to the security of the delivery system because conventional transcoding operations generally require that an encrypted stream be decrypted before transcoding. The transcoded result is re-encrypted but is decrypted at the next transcoder. Each transcoder thus presents a possible breach in the security of the system. This is not an acceptable situation when end-to-end security is required.

Compression, or encoding, techniques are used to reduce the redundant information in data, thereby facilitating the storage and distribution of the data by, in effect, reducing the quantity of data. The JPEG (Joint Photographic Experts Group) standard describes one popular, contemporary scheme for encoding image data. While JPEG is satisfactory in many respects, it has its limitations when it comes to current needs. A newer standard, the JPEG2000 standard, is being developed to meet those needs. In a similar manner, there have been a sequence of video compression standards including H.261/2/314 and MPEG-1/214/21, speech and audio coding standards such as AMR and MC and scalable MC, as well as other standards for compressing other types of media, e.g. graphics. As mentioned above, an important design goal for media compression standards and systems is the ability to adapt or transcode to different downstream network conditions and client capabilities.

A checksum is a mathematical value that is assigned to a file and used to authenticate the file at a later date to verify that the data contained in the file has not been modified. Moreover, a cryptographic checksum (CCS) is a checksum whose authenticating mathematical value is a function of an authentication key. A cryptograhic checksum (CCS) is created by performing a complicated series of mathematical operations (known as a cryptographic algorithm) that translates the data in the file and the key into a fixed string of digits. A cryptographic checksum is also often referred to as a Message Authentication Code (MAC). A variety of different algorithms exist for computing cryptographic checksums. For example, they may be computed using a block cipher, such as the popular Digital Encryption Standard (DES) or the Advanced Encryption Standard (AES), in cipher block chaining (CBC) mode. This class of approaches is usually referred to as CBC-MAC approaches, since they use a block cipher in CBC mode and the resulting output is used as a message authentication code. Another popular class of algorithms involves using a hash function and these may be referred to as hash-based cryptographic checksums or hash-based MACs. Note that these algorithms are also referred to by a number of other names, e.g. keyed hash. A popular algorithm is HMAC which can be used with a variety of hashes including MD5, SHA-1, SHA-256, RIPEMD, etc. In these cases the resulting CCS value (or hash-based MAC value) is a function of a key. Integrity checks are another form of authentication check, however it should be noted that sometimes integrity checks may be performed with a key and sometimes without a key. Clearly, the integrity checks with a key prevent someone without access to that key from computing the integrity check (for either malicious reasons or conventional verification reasons), however an integrity check without a key allows anyone to compute the integrity check (for verification or for replacement of the original integrity check value). Digital signatures are another security technique that provide a cryptographic checksum service, plus additional services. Cryptographic checksums are widely used in both data transmission and data storage applications.

Conventional CCS approaches require that a CCS be computed for each file or file portion to which a CCS is to be associated. This requirement necessitates that separate CCS computations be performed if separate CCSs are desired for a file itself and for subsets of that file. Consequently, this requires that a cryptographic algorithm be applied a plurality of times for the same file data content in order to generate the desired CCSs. This requirement exacts a significant cost in central processing unit (CPU) utilization and adds significantly to cryptographic algorithm computational complexity.

### DISCLOSURE OF THE INVENTION

A method for utilizing a single cryptographic integrity check to generate multiple cryptographic integrity check values for components of content is disclosed. In one embodiment, a single cryptographic integrity check for content is initiated, where the content includes a plurality of components. It should be appreciated that when the cryptographic integrity check has completed for at least one of the plurality of components, a cryptographic integrity check value is recorded for the at least one of the plurality of components. The single cryptographic integrity check is completed to generate a cryptographic integrity check value for the at least one of the plurality of components.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a system for utilizing a single cryptographic integrity check to generate cryptographic integrity check values for components of content and for content in its entirety according to one embodiment of the present invention.

FIG. 2 shows functional components of a cipher block chain-message authentication code (CBC-MAC) system according to one embodiment of the present invention.

FIG. 3 illustrates an example of the computational complexity savings of the cryptographic integrity check according to one embodiment of the present invention.

FIG. 4A shows the functional components of a hash-based authentication system according to an embodiment of the present invention.

FIG. 4B shows the functional components of a hash-based authentication system according to an embodiment of the present invention.

FIG. 4C shows the functional components of a hash-based authentication system according to an embodiment of the present invention.

FIG. 5 shows a flowchart of the steps performed in a method of utilizing a single cryptographic integrity check to generate cryptographic integrity check values for components of content.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

For purposes of the following discussion the term “transcodable content” is intended to refer to content that is serviceable by a transcoder. In addition, the terms “independently encryptable”, “independently decodable” and “independently authenticatable” are intended to refer to independently identifiable content components that can be respectively independently (e.g., separately) encrypted/decrypted, encoded/decoded and authenticated.

It should be appreciated that when a component is independently decodable the bits comprising the component can be decoded without requiring other bits not present in the component. However, the component alone may not be sufficient to recover the original media signal. For example, in MPEG with I, P, and B frames, each P or B frame is independently decodable, however additional coded frames (e.g. the prior I frame) is required to accurately reconstruct the video signal. By independently authenticatable, what is meant is that a component of transcodable content can have a message authentication code (MAC) (also referred to as an integrity check or cryptographic checksum) for verifying that the component has not changed. It should be noted that a change can be intentional, such as by a malicious attacker, or unintentional, such as by a channel error.

### Cryptographic Integrity Check System According to Embodiments of the Present Invention

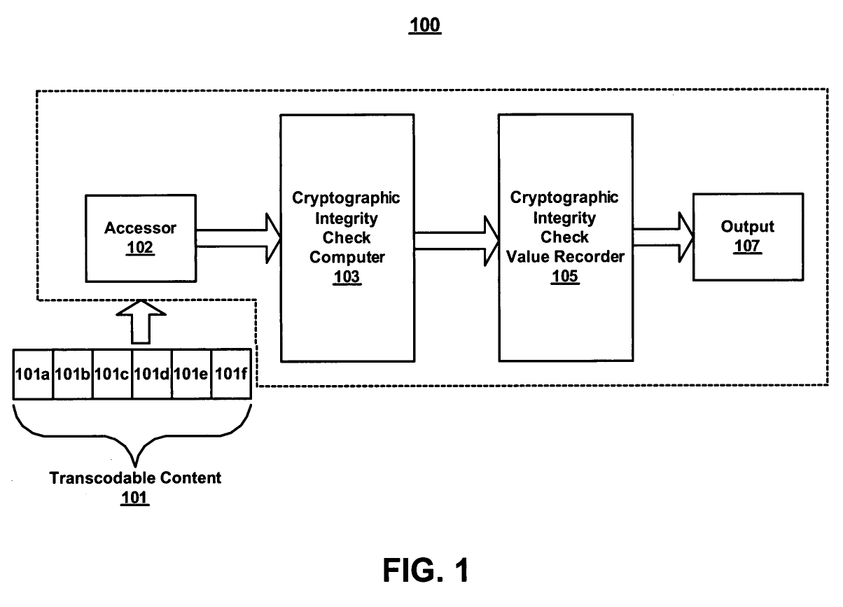

FIG. 1 shows a cryptographic integrity check system (CICS) 100 for utilizing a single cryptographic integrity check to generate cryptographic integrity check values for portioned components of transcodable content (e.g., 101a-101f) and/or for the transcodable content (e.g., 101) in its entirety according to one embodiment of the present invention. The following discussion will begin with a description of the physical structure of the present invention. This discussion will then be followed with a description of the operation of the present invention. With respect to the physical structure of the present invention, FIG. 1 shows transcodable content 101, components of transcodable content 101a-101f, accessor 102, cryptographic integrity checke computer 103, cryptographic integrity check value recorder 105, and output 107.

In the present embodiment, a single cryptographic integrity check for transcodable content (e.g., 101) is initiated and completed to generate a cryptographic integrity check value for at least one of a plurality of components of the transcodable content (e.g., 101a-101f), and/or to generate a cryptographic integrity check value for the transcodable content (e.g., 101) in its entirety. Accessor 102 accesses transcodable content 101 supplied by a source of transcodable content 101 (e.g., such as a server, storage medium etc.). Accessor 102 is coupled to the cryptographic integrity check computer 103 and supplies transcodable content 101 to the cryptographic integrity check computer 103. Transcodable content 101 is comprised of components of transcodable content 101a-101f. Transcodable content 101 is supplied by a source of transcodable content (e.g., such as a server, data storage medium etc.) to accessor 102.

According to one embodiment, transcodable content 101 can be encoded in a manner that facilitates transcoding such as by a transcoder (not shown). According to one embodiment, transcodable content 101 can be transcoded by the selection and combining of a selected subset of the components of transcodable content (e.g., 101a-101f) that constitute transcodable content 101. According, to one embodiment, the resulting transcoded content is also transcodable.

It should be appreciated that transcodable content 101 may include associated information (e.g., an unencrypted header) that provides hints or explicit directions for performing the transcoding of transcodable content 101. These hints may include the rate-distortion (R-D) consequences for keeping or discarding the content in question. They may also include information about the dependence of this content on other content. Alternative information may include the acquisition/capture or display/presentation timestamp, media type (video or speech), or scalability information (e.g. spatial resolution, frame rate, bandwidth, subband information, bit rate, quality layer, bit plane, color component, channel for audio (single, which stereo channels, specific channels in a multichannels audio program, etc)).

CICS 100 further includes a cryptographic integrity check computer 103 coupled to accessor 102. Cryptographic integrity check computer 103 accesses transcodable content 101 that is supplied by accessor 102. In the present embodiment, cryptographic integrity check computer 103 computes a single cryptographic integrity check for transcodable content 101 that is comprised of components of transcodable content 101a-101f. As mentioned above, the operation of cryptographic integrity check computer 103 is discussed below in detail.

Cryptographic integrity check value recorder 105 records integrity check values determined for transcodable content 101 in its entirety and for desired components of transcodable content 101a-101f. Cryptographic integrity check value recorder 105 is coupled to cryptographic integrity check computer 103 and records a cryptographic integrity check value supplied therefrom for at least one of the components of transcodable content 101a-101f when the cryptographic integrity check has completed for that component of transcodable content (e.g., 101a-101f. It should be appreciated that the cryptographic integrity check value recorder 105 records a cryptographic integrity check value for transcodable content 101 in its entirety when the cryptographic integrity check computation for transcodable content 101 in its entirety is completed.

Output 107 outputs a cryptographic integrity check value for at least one of the components of transcodable content 101a-101f (if desired) and also for the transcodable content 101 in its entirety. It should be appreciated that output 107 is coupled to the cryptographic integrity check value recorder 105 and accesses integrity check values therefrom.

### Cryptographic Integrity Check System in Operation According to one Embodiment of the Present Invention

The following discussion sets forth in detail the operation of the present invention. As is shown in FIG. 1, transcodable content 101 (including components of transcodable content 101a-101f) is accessed by accessor 102 which supplies the transcodable content 101 to cryptographic integrity check computer 103. Cryptographic integrity check computer 103 performs a single integrity check on transcodable content 101 that generates therefrom integrity checks for specified components of transcodable content 101a-101f and/or for the transcodable 101 in its entirety. Integrity checks for the specified components of transcodable content 101a-101f and for the transcodable content 101 in its entirety are recorded by cryptographic integrity check value recorder 105 and are made accessible at output 107.

It should be appreciated that the single cryptographic integrity check for transcodable content 101 is initiated and completed to generate a cryptographic integrity check value for at least one of a plurality of components of the transcodable content 101a-101f, and also to generate a cryptographic integrity check value for the transcodable content 101 in its entirety.

In one embodiment, cryptographic integrity check values corresponding to desired components (e.g., 101a-101f) of a measure of transcodable content 101, for which a cryptographic integrity check is being computed, are recorded in a lookup table during the computation of the cryptographic integrity check. In other embodiments, other suitable methods (e.g., such as various types of storage devices) of recording the correspondence between components of transcodable content 101 and their corresponding cryptographic integrity check values can be employed.

Different applications may desire to compute cryptographic integrity check values for different components. For example, it may be desired to compute cryptographic integrity check values for any desired subset of the components of the transcodable content. For instance, it may be desireable to compute associated cryptographic integrity check values for all possible subsets of components, i.e. if there are N different components, and if all possible subsets of the N components are possible then there are 2ˆN possible subsets. For example, in the case of three components {A,B,C}, then the possible subsets are {A}, {B}, {C}, {A,B}, {A,C}, {B,C}, {A,B,C} and the empty subset { }.

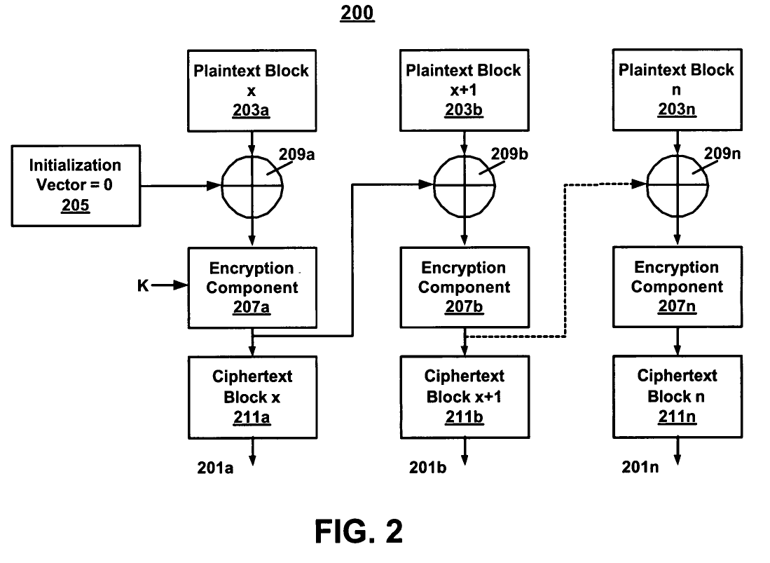

In one embodiment, an identification of transcodable components (e.g., components of transcodable content 101a-101f) of a bitstream (e.g., of transcodable content 101) is made and an associated integrity check is computed. Specifically, a block cipher in cipher block chain (CBC) mode with an initialization vector (IV) of zero is applied to each transcodable component (e.g., components of transcodable content 101a-101f) of the transcodable content to be authenticated. The last block of the resulting CBC output is used as the integrity check (or message authentication code). This approach can be referred to as CBC-MAC (see FIG. 2 discussion below).

It should be noted that the length of the MAC can be lengthened or shortened as a means of arriving at the appropriate tradeoff between the cost paid in bits for the MAC and the MACs probability of detecting a change in the content. It should be appreciated that the probability of a different message providing the same MAC value is approximately 2ˆ(−L) where L is the length of the MAC in bits. As such, longer MACs provide better protection at the expense of requiring more bits (e.g., overhead). Consequently, according to exemplary embodiments, the length of the MAC associated with each measure of content can be adapted to provide a desired level of security.

In one embodiment, a MAC is computed as described herein for each transcodable component (e.g., component of transcodable content 101a-101f) of a bitstream (e.g., transcodable content 101). Subsequently, the transcodable components of the bitstream (e.g., transcodable content 101) and their associated MACs are composited together. It should be appreciated that the composite bitstream can then be encrypted using a stream cipher mode encryption scheme. Consequently, fine grain granularity is affected that features a fine grain location of truncation points (e.g., such as for transcoding). In this manner, the truncation points are configured to coincide with transcodable components (e.g., components of transcodale content 101a-101f) of the bitstream (e.g., transcodable content 101) and associated MACs.

In an alternate embodiment, instead of truncations different subsets of the encrypted bitstream can be chosen, where the subsets are defined by appropriate boundaries (truncation implicitly assumes that the first boundary is at the beginning of the content). In exemplary embodiments, each one of the truncations can be selected to provide an encrypted set of bits which is independently decryptable, independently authenticatable, and independently decodable.

It should be appreciated that in the present embodiment, MACs can be appended at the end of transcodable content (e.g., 101), can be placed out of band, or can be interspersed throughout transcodable content (e.g., 101). In the present embodiment, transcodable content (e.g., 101) is enabled to be decrypted independently of other proximately located transcodable content (e.g., 101).

In one embodiment, a cryptographic integrity check is computed for each one of the plurality of components of transcodable content (101a-101f) that constitutes the transcodable content (e.g., 101). In another embodiment, a first cryptographic integrity check is calculated for a first component of transcodable content, and a second cryptographic integrity check is calculated for the combination of a second component of transcodable content, the first component of transcodable content, and the first cryptographic integrity check. Alternatively, the second cryptographic integrity check may be calculated for the combination of the first and second components of transcodable content.

In one embodiment, the cryptographic integrity check is computed using a CBC-MAC. In another embodiment, the cryptographic integrity check is computed using a hash function, for example an HMAC algorithm using SHA-1. In another embodiment, the cryptographic integrity check is computed using other suitable methods of computing the cryptographic integrity check.

FIG. 2 shows the functional components of a cipher block chain-message authentication code (CBC-MAC) system 200 according to one embodiment of the present invention. FIG. 2 shows components of transcodable content (e.g., 101a-101f of FIG. 1) intermediate access points 201a-201n, plaintext block×203a, plaintext block x+1 203b, plaintext block n 203n, initialization vector 205, encryption components 207a-207n, logical combiners 209a-209n, ciphertext block×211a, ciphertext block X+1 211b, and ciphertext block n 211n.

In the present embodiment, blocks of content x, x+1 and n are supplied as inputs to CBC-MAC system 200 (e.g., 203a-203n). The ciphertext of block x (e.g., 211a, encrypted by encryption component 207a) is logically combined (e.g., XORed) by logical combiner 209b with the plaintext of block x+1 (e.g., 203b) before it is encrypted (by encryption component 207b). Subsequently, the ciphertext of block x+1 (e.g., 211b) is logically combined (e.g., XORed) by logical combiner 209n with the plaintext of block n (e.g., 203n) before it is encrypted (by encryption component 207n). In one embodiment, the plaintext of block x (e.g., 203a) is initially logically combined by logical combiner 209a with an initialization vector 205 of zero.

A feature of the internal structure of the CBC-MAC system 200 of FIG. 2 is that intermediate components of transcodable content (e.g., 101a-101f of FIG. 1) are made accessible during a single cryptographic integrity check session (via components of transcodable content 101a-101f intermediate access points 201a-201n). In the present embodiment, components of transcodable content (e.g., 101a-101f of FIG. 1) corresponding to blocks of content x, x+1 and n are accessible at intermediate access points 201a-201n as is illustrated in FIG. 2.

In the present embodiment, the internal structure of the CBC-MAC system 200 noted above is exploited such that intermediate cryptographic integrity check values that correspond to components of transcodable content (e.g., 101a-101f of FIG. 1) and/or the transcodable content (e.g., 101 of FIG. 1) in its entirety are computed and recorded during a single cryptographic integrity check session. These values are based on outputs that correspond to components of transcodable content (e.g., ciphertext block×201a and ciphertext block x+1 211b) and transcodable content in its entirety (e.g., ciphertext block 211n), accessible respectively at outputs 201a, 201b and 201n.

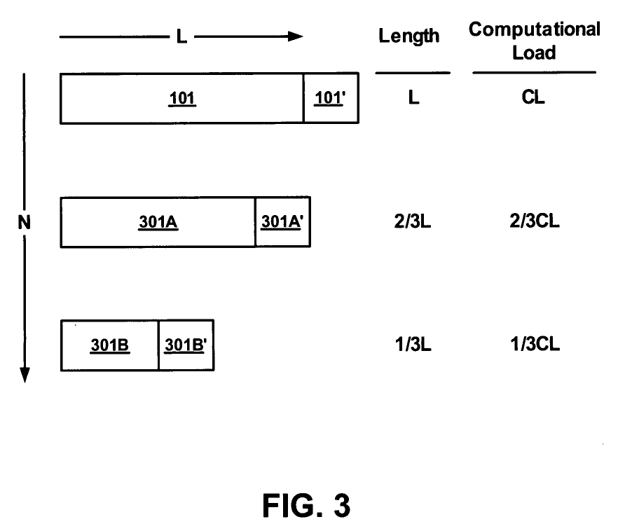

FIG. 3 illustrates an example of the computational load savings of the cryptographic integrity check methodology according to one embodiment of the present invention. FIG. 3 shows transcodable content 301 and components of transcodable content 301a and 301b, and cryptographic integrity checks 301′, 301A′ and 301B′. The computational cost of computing a cryptographic integrity check for data of length L is approximately CL, i.e. it is proportional to the length of the data where the proportionality constant is denoted by C. One can also view C as the computational cost per unit length of data for computing the cryptographic integrity check.

In the FIG. 3 example, it can be seen that transcodable content 301, and components of transcodable content 301a and 301b can be seen as forming a triangle having base L and height N. Consequently, it should be appreciated that the computational load involved in computing separate cryptographic integrity checks for transcodable content 301, and components of transcodable content 301a and 301b using conventional approaches may be given by:
computational load_{conventional}=½CNL
where N corresponds to the number of components of transcodable content (e.g., 301a and 301b) and transcodable content itself (e.g., 301) involved in the computations.

By contrast, in the present embodiment, because the internal structure of the CBC-MAC is exploited as discussed above with reference to FIG. 2, and the cryptographic integrity checks for transcodable content 301, and components of transcodable content 301a and 301b are recorded during a single cryptographic integrity check session, the CPU utilization involved in computing cryptographic integrity checks for transcodable content 301 (e.g., 301′), and components of transcodable content 301a and 301b (e.g., 301a′ and 301b′) in exemplary embodiments is equal to CL. Consequently, in the FIG. 3 example, a savings in CPU utilization equal to ½N is realized over conventional approaches. For example, if N=10, then the present embodiment provides approximately a factor of 5 improvement in CPU utilization as compared to the conventional approaches.

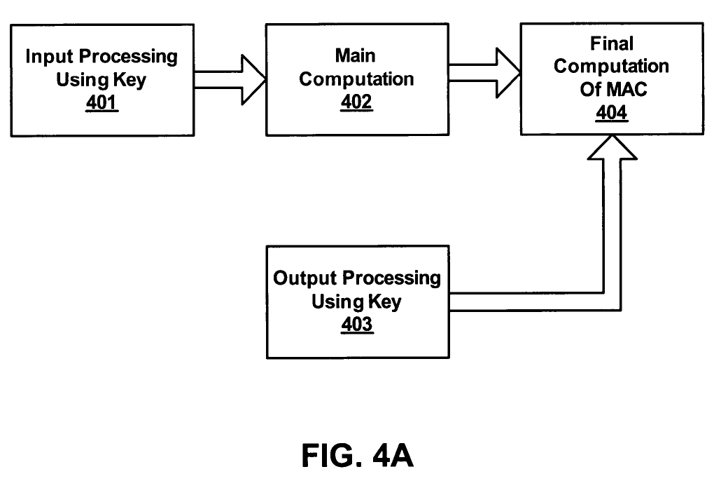

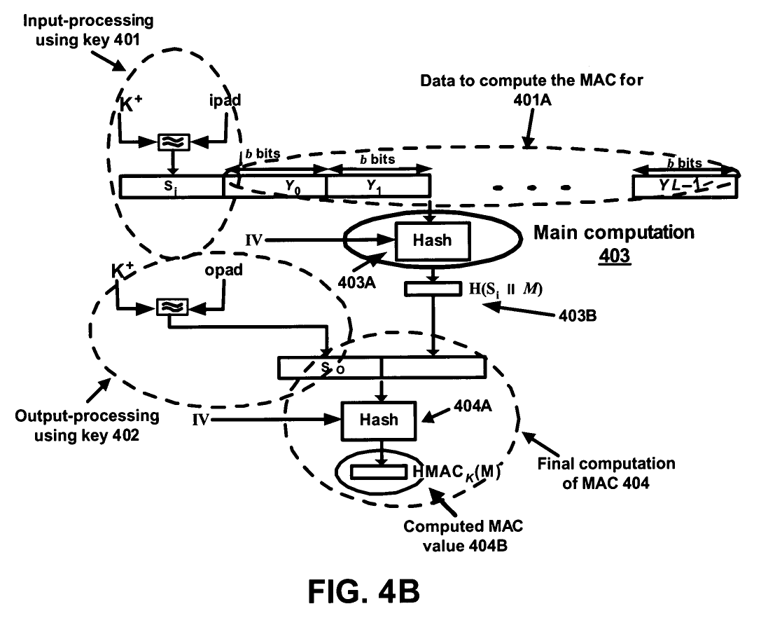

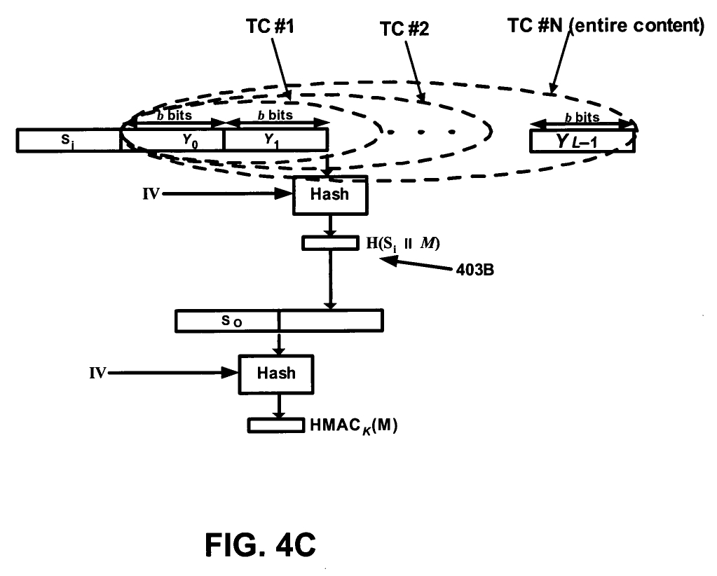

FIGS. 4A-4C show the functional components of a hash-based authentication system according to an embodiment of the present invention. In particular, these figures are based on the use of the HMAC algorithm, which may be used with a number of different hash functions. The HMAC algorithm consists of four basic operations illustrated in FIG. 4A: (401) an input-processing using a key (shown having inputs k and ipad and output Sₗ in FIG. 4B), (402) an output-processing using a key (shown as having inputs K and opad and output Sₒ in FIG. 4B), (403) the main computation where the hash (403A of FIG. 4B) is computed of the data (401A of FIG. 4B) concatenated with the input-processed result from (401), and (404) the final computation of the MAC (e.g., 404B of FIG. 4B) using the computed hash (403B of FIG. 4B) from (403) and the output processing from (402). Note that (401) and (402) only depend on the key, are easy to compute, and can be pre-computed and stored and used multiple times (when the key is used multiple times). Also, operation (404) is a single hash computation of a very short string of bits. However, operation (403) is a hash computation of the original data (which can be quite long) and this leads to a large majority of the required computation whenever HMAC is used.

In FIG. 4C, we consider the case of transcoding the content to N different segments, denoted by transcodable content # 1 (TC #1), transcodable content #2 (TC #2), . . . , to transcodable content #N (TC #N) which corresponds to the entire content. The present embodiment enables us to efficiently compute cryptographic integrity checks or MACs for all N transcodable contents (shown as Yₒ through Y_{L-1} in FIGS. 4B and 4C).

In the present embodiment, operations (401) and (402) can be performed and a computed value stored for use in computing the MACs for all N possible transcodable contents. This is assuming the case when each transcodable content uses the same key. If they use different keys, operations (401) and (402) are performed with different keys. In a similar manner to our embodiment for the use of a CBC-MAC, as shown in FIG. 2, here we once again exploit the internal structure of the hash computation (at operation 403) to extract intermediate values of the computation corresponding to the hashed results of TC#1, TC#2, . . . TC#N. Each of these intermediate values are then processed at operation (404) to compute the desired MAC values associated with TC#1, TC#2, . . . , TC#N. In this embodiment the operations (401), (402), and (403) are performed only once. Furthermore, operation (404) requires almost negligible CPU usage as compared to operation (403). Hence the required complexity is approximately the same as computing only a single HMAC for the entire content, e.g. for TC#N. Therefore, this approach provides the ability to compute the MACs for N transcodable contents (TC#1, . . . ,TC#N) with approximately the computational requirements of computing a single MAC for TC#N. In contrast, the conventional approach would require to compute N MACs separately, which would require the computations of approximately N times the computations required for TC#N. Hence, the proposed embodiment provides an improvement in complexity of a factor N/2 as realized by conventional approaches.

It should be appreciated that in alternate embodiments other security techniques can be employed to provide authentication. In one embodiment digital signatures can be employed to provide authentication and/or other security services. When employed, such techniques can be used in a manner such as is described with regard to the CBC-MAC and the HMAC systems discussed above, where the extraction of intermediate values that correspond to components of transcodable content is facilitated.

### Exemplary Operations in Accordance with Embodiments of the Present Invention

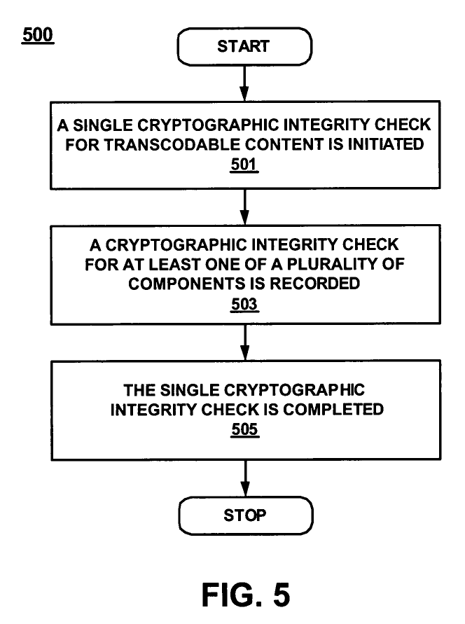

FIG. 5 shows a flowchart 500 of the steps performed in processes of the present invention which, in one embodiment, are carried out by processors and electrical components under the control of computer readable and computer executable instructions. The computer readable and computer executable instructions reside, for example, in data storage memory units. However, the computer readable and computer executable instructions can reside in other types of computer readable medium. Although specific steps are disclosed in the flowcharts, such steps are exemplary. That is, the present invention is well suited to performing various other steps or variations of the steps recited in the flowcharts. Within the present embodiment, it should be appreciated that the steps of the flowcharts may be performed.

FIG. 5 shows a flowchart of the steps performed in a method of utilizing a single cryptographic integrity check to generate cryptographic integrity check values for components of transcodable content according to one embodiment of the present invention.

At step 501, a single cryptographic integrity check for transcodable content (e.g., 101 of FIG. 1) is initiated for transcodable content comprised of a plurality of components. In one embodiment, an accessor (e.g., 102 of FIG. 1) accesses transcodable content (e.g., 101 of FIG. 1) that is supplied by a source of transcodable content (e.g., such as a server, storage medium etc.). In the present embodiment, the accessor (e.g., 102 of FIG. 1) is coupled to a cryptographic integrity check computer (e.g., 103 of FIG. 1) and supplies transcodable content (e.g., 101 of FIG. 1) to the cryptographic integrity check computer (e.g., 103 of FIG. 1).

A cryptographic integrity check computer (e.g., 103 of FIG. 1) is coupled to an accessor (e.g., 102 of FIG. 1) and accesses content (e.g., 101 of FIG. 1) supplied by the accessor (e.g., 102 of FIG. 1). Cryptographic integrity check computer (e.g., 103 of FIG. 1) performs a single cryptographic integrity check computation for transcodable content (e.g., 101 of FIG. 1) that is comprised of the components of transcodable content (e.g., 101a-101f of FIG. 1).

At step 503, a cryptographic integrity check value for at least one of the plurality of components of transcodable content (e.g., 101a-101f of FIG. 1) is recorded. In the present embodiment, a cryptographic integrity check value is recorded for at least one of the plurality of components of transcodable content (e.g., 101a-101f of FIG. 1) when the cryptographic integrity check has completed for the at least one of the plurality of components of transcodable content (e.g., 101a-101f of FIG. 1).

In one embodiment, a cryptographic integrity check value recorder (e.g., 105 of FIG. 1) records integrity check values for transcodable content (e.g., 101 of Figure) in its entirety and for desired components of transcodable content (e.g., 101a-101f) of FIG. 1). It should be appreciated that the cryptographic integrity check value recorder (e.g., 105 of FIG. 1 records a cryptographic integrity check value for at least one of the components of transcodable content (e.g., 101a-101f of FIG. 1) when the cryptographic integrity check has completed for that component of transcodable content (e.g., 101a-101f of FIG. 1) and for the transcodable content (e.g., 101 in FIG. 1) in its entirety when the cryptographic integrity check is completed.

At step 505, a single cryptographic integrity check is completed to generate a cryptographic integrity check value for at least one of the plurality of components of transcodable content (e.g., 101a-101f of FIG. 1) and also to generate a cryptographic integrity check value for the transcodable content (e.g., 101 in FIG. 1) in its entirety.

In one embodiment, an output (e.g., 107 of FIG. 1) outputs a cryptographic integrity check value for at least one of the components of transcodable content (e.g., 101a-101f of FIG. 1) and also for the transcodable content in its entirety. It should be appreciated that output (e.g., 107 of FIG. 1) is coupled to the cryptographic integrity check value recorder (e.g., 105 of FIG. 1) and accesses integrity check values therefrom.

In summary, embodiments of the present invention provide methods and systems for utilizing a single cryptographic integrity check computation to generate cryptographic integrity check values for components of transcodable content. In one embodiment, a single cryptographic integrity check for transcodable content is initiated, where the transcodable content includes a plurality of components. It should be appreciated that when the cryptographic integrity check has completed for at least one of the plurality of components, a cryptographic integrity check value is recorded for the at least one of the plurality of components. The single cryptographic integrity check is completed to generate a cryptographic integrity check value for the at least one of the plurality of components.

The foregoing descriptions of specific embodiments of the present invention have been presented for purposes of illustration and description. They are not intended to be exhaustive or to limit the invention to the precise forms disclosed, and it is evident many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of utilizing a single cryptographic integrity check to generate multiple cryptographic integrity check values for components of transcodable content, said method comprising:
initiating said single cryptographic integrity check for transcodable content, wherein said transcodable content is comprised of a plurality of said components of transcodable content;
when said cryptographic integrity check has completed for at least one of said plurality of components of transcodable content, recording a cryptographic integrity check value for said at least one of said plurality of said components of transcodable content; and
completing said single cryptographic integrity check to generate a cryptographic integrity check value for said at least one of said plurality of said components of transcodable content.

2. The method as recited in claim 1 wherein said of plurality of components of transcodable content comprises transcodable portions of a bitstream.

3. The method as recited in claim 1 wherein said cryptographic integrity check comprises a cryptographic checksum (CCS).

4. The method as recited in claim 3 wherein said CCS is selected from the group consisting of cipher block chain-media authentication code (CBC-MAC), hash based MAC (HMAC), and digital signatures.

5. The method as recited in claim 2 wherein said transcodable portions of said bitstream comprises a block cipher applied in cipher block chain (CBC) mode with an initialization vector of zero.

6. The method as recited in claim 5 wherein said block cipher applied in CBC mode comprises:
outputting a last cipher block that is used for integrity checking.

7. The method as recited in claim 1 further comprising:
associating a media authentication code (MAC) with a component of transcodable content wherein the length of said MAC associated with said component of transcodable content determines a level of security.

8. The method as recited in claim 7 wherein a plurality of said components of transcodable content and their associated MACs are composited together.

9. The method as recited in claim 7 wherein said plurality of said components of transcodable content and their associated MACs are encrypted.

10. The method as recited in claim 7 wherein said plurality of said components of transcodable content and their associated MACs are encrypted using a block cipher in stream cipher mode.

11. The method as recited in claim 2 wherein said components of transcodable content are independently decryptable, independently authenticatable, and independently decodable.

12. The method as recited in claim 1 wherein said cryptographic integrity check comprises a plurality of CCSs whose location is selected from the group consisting of interspersed within said transcodable content, out of band, and at the end of said transcodable content.

13. A computer useable medium having computer useable code embodied therein that causes a computer to perform operations comprising:
initiating a single cryptographic integrity check for transcodable content, wherein said transcodable content is comprised of a plurality of components of transcodable content;
when said cryptographic integrity check has completed for at least one of said plurality of components of transcodable content, recording a cryptographic integrity check value for said at least one of said plurality of said components of transcodable content; and
completing said single cryptographic integrity check to generate a cryptographic integrity check value for said at least one of said plurality of said components of transcodable content.

14. The computer useable medium as recited in claim 13 wherein said plurality of components of transcodable content comprises transcodable portions of a bitstream.

15. The computer useable medium as recited in claim 13 wherein said cryptographic integrity check comprises a cryptographic checksum (CCS).

16. The computer useable medium as recited in claim 15 wherein said CCS is selected from the group consisting of cipher block chain-media authentication code (CBC-MAC), hash based MAC (HMAC), and digital signatures.

17. The computer useable medium as recited in claim 14 wherein said transcodable portions of said bitstream comprise a block cipher applied in CBC mode with an initialization vector of zero.

18. The computer useable medium as recited in claim 17 wherein said block cipher applied in CBC mode comprises:
outputting a last block cipher that is used for integrity checking.

19. The computer useable medium as recited in claim 13 further comprising:
associating a media authentication code (MAC) with a component of transcodable content wherein the length of said MAC associated with said component of transcodable content determines a level of security.

20. The computer useable medium as recited in claim 19 wherein a plurality of said components of transcodable content and their associated MACs are composited together.

21. The computer useable medium as recited in claim 19 wherein said plurality of said components of transcodable content and their associated MACs are encrypted.

22. The computer useable medium as recited in claim 19 wherein said plurality of said components of transcodable content and their associated MACs are encrypted using a block-cipher in stream-cipher mode.

23. The computer useable medium as recited in claim 14 wherein said components of transcodable content are independently decryptable, independently authenticatable, and independently decodable.

24. The method as recited in claim 13 wherein said cryptographic integrity check generates a plurality of CCSs whose locations are selected from the group consisting of interspersed within said transcodable content, out of band, and at the end of said transcodable content.

25. A system for utilizing a single cryptographic integrity check to generate cryptographic integrity check values for components of transcodable content, said system comprising:
an accessor for accessing said components of transcodable content;
a cryptographic integrity check computer coupled to said accessor that performs said single cryptographic integrity check for said transcodable content, wherein said transcodable content is comprised of a plurality of said components of transcodable content;
a cryptographic integrity check value recorder coupled to said cryptographic integrity check computer that records a cryptographic integrity check value for said at least one of said plurality of said components of transcodable content when said cryptographic integrity check has completed for said at least one of said plurality of components of transcodable content, and which also records a cryptographic integrity check value for said transcodable content in its entirety; and
an output coupled to said cryptographic integrity check value recorder for outputting said cryptographic integrity check value for said at least one of said plurality of components of transcodable content.

26. The system of claim 25 wherein said cryptographic integrity check computer is configured to compute a cryptographic integrity check for said transcodable content wherein said transcodable content comprises transcodable portions of a bitstream.

27. The system of claim 25 wherein said cryptographic integrity check value recorder is configured to associate a cryptographic integrity check with at least one of said plurality of components of said transcodable content wherein said cryptographic integrity check comprises a cryptographic checksum (CCS).

28. The system of claim 27 wherein said CCS is selected from the group consisting of cipher block chain-media authentication code (CBC-MAC), hash based MAC (HMAC), and digital signatures.

29. The system of claim 25 further comprising a cipher block chain-message authentication code (CBC-MAC) sub-system wherein said CBC-MAC sub-system is configured to apply a block cipher in (CBC) mode with an initialization vector of zero to said transcodable portions of said bitstream.

30. The system of claim 29 wherein said CBC-MAC sub-system further comprises:
an output for outputting a last block that is used for integrity checking.

31. The system of claim 25 wherein said cryptographic integrity check computer associates a MAC with a component of transcodable content wherein the length of said MAC associated with said component of transcodable content of said bitstream determines an associated level of security.

32. The system of claim 25 wherein said components of transcodable content are independently decryptable, independently authenticatable, and independently decodable.

33. The system of claim 25 wherein said cryptographic integrity check computer generates a plurality of CCSs whose locations are selected from the group consisting of interspersed within said transcodable content, out of band, and at the end of said transcodable content.
